(19) United States
(12) Patent Application Publication
(10) Pub. No.: US 2010/0112988 A1
(43) Pub. Date: May 6, 2010

(54) WIRELESS COMMUNICATION TERMINAL AND METHOD FOR WIRELESS COMMUNICATION

(75) Inventor: Toshiya TAMURA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/607,245

(22) Filed: Oct. 28, 2009

(30) Foreign Application Priority Data
Oct. 31, 2008 (JP) 2008-282339

(51) Int. Cl. H04M 3/42; H04B 7/00

(52) U.S. Cl. 455/414.1; 455/41.3

(57) ABSTRACT

A wireless communication terminal, such as a mobile phone, controls an establishing of a phonebook forwarding session based on an authentication for a hands-free session. The phonebook forwarding session is established between the wireless communication terminal and a device if the wireless communication terminal determined the device is authenticated for a hands-free session.

### CROSS-REFERENCE TO RELATED APPLICATION

The present invention claims the benefit of priority under 35 USC 119 of Japanese Patent Application No. 2008-282339, filed on Oct. 31, 2008, the entire contents of which are incorporated herein by reference.

### BACKGROUND

1. Technical Field

The present invention relates to a wireless communication terminal.

2. Related Art

A technology has been known which forwards phonebook data between a nearby hands-free device and a wireless communication terminal, using wireless communication. For example, with Bluetooth®, there is the Phone Book Access Profile (PBAP) as a profile for forwarding phonebook data. For example, Japanese Patent Publication (Kokai), No. 2008-98767 shows a car kit which can obtain phonebook data from a mobile phone by using PBAP.

It is common that a hands-free device, such as a car kit, is equipped with a hands-free profile (HFP), which is a profile for realizing a function to receive a call and to make a call by the hands-free device, and an advanced audio distribution profile (A2DP), which is a profile for transmitting a voice. The device which supports HFP and A2DP often carries out pairing procedures for both of the profiles to authenticate an external device which supports HFP and A2DP. This is in order to avoid a problem, for example, when the hands-free device requests another device to reproduce music, the requests cannot to be accept due to the other device not supporting A2DP. In the event that the car kit activates not only the HFP and A2DP, but also the PBAP, it is necessary to carry out a pairing for the PBAP, too. With the PBAP, the car kit requests the mobile phone to forward phonebook data in the mobile phone. For this reason, from a point of view of security, it is extremely important for the mobile phone to carry out an authentication of the device to which the phonebook data are to be forwarded. However, in the event that the pairing is carried out not only for the HFP and A2DP, but also for the PBAP, the pairing is executed three times, causing an increase in trouble for a user.

### SUMMARY

A hands-free device includes: A wireless communication terminal, comprising: a first radio interface to communicate with a device by a short-range wireless communication; a memory to store phone book data; and a phonebook access control unit to establish a session for phonebook forwarding with the device when the device has been authenticated for a hands-free session which is a session for connecting the device and the wireless communication terminal by the short-range wireless communication.

### BRIEF DESCRIPTION OF THE DRAWINGS

Exemplary embodiments of the present invention will be described in detail based on the following figures, wherein:

FIG. 1 is a diagram showing a relationship between a mobile phone according to an embodiment of the invention and a car kit wirelessly connected thereto;

FIG. 2 is a block diagram showing a configuration of the mobile phone according to the embodiment of the invention;

FIG. 3 is a block diagram showing a configuration of the car kit wirelessly connected to the mobile phone according to the embodiment of the invention;

FIG. 4 is a flowchart showing a process when the mobile phone according to the embodiment of the invention receives a session establishment request for a hands-free function;

FIG. 5 is a flowchart showing a process when the mobile phone according to the embodiment of the invention receives a session establishment request for a phonebook forwarding function;

FIG. 6 is a sequence diagram showing a process from a condition in which no hands-free session is established between the mobile phone according to the embodiment of the invention and the car kit, until a phonebook forwarding is carried out from the mobile phone to the car kit; and

FIG. 7 is a flowchart showing a process when a mobile phone according to another embodiment of the invention receives a session establishment request for a phonebook forwarding function.

### DETAILED DESCRIPTION OF THE INVENTION

Exemplary embodiments of the present invention will be described hereinafter with reference to the accompanying drawings.

Herein, a description will be given of, as an example, a case of a car kit retrieves phone book data from a mobile phone by short range wireless communication such as Bluetooth®. However, a device that retrieves phone book is not limited to a car kit, it can be another device such as a head set and a personal computer.

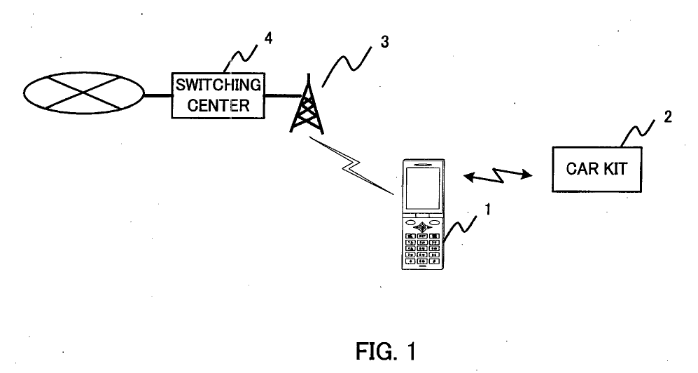

FIG. 1 is a diagram showing a relationship between a mobile phone 1 according to the embodiment and a car kit 2 wirelessly connected thereto. The mobile phone 1 can carry out a transmission and reception of information with the car kit 2 by Bluetooth®.

Also, the mobile phone 1 is connected to a network via a base station 3 and switching center 4, and can carry out voice communication and data communication. Also, the mobile phone 1, including a hands-free control unit for enabling a voice communication between the car kit 2 and the network, forwards information received from the base station 3 to the car kit 2, via Bluetooth®, and transmit information received from the car kit to the base station 3.

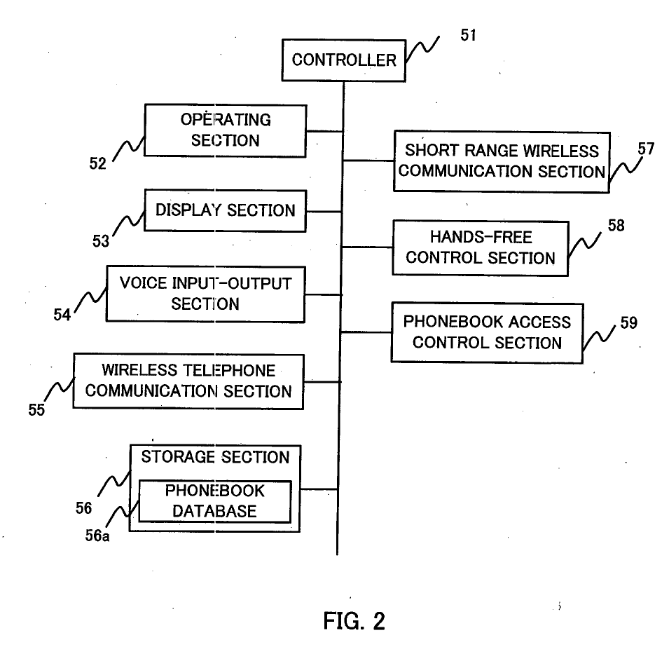

FIG. 2 is a block diagram showing a configuration of the mobile phone according to the embodiment. The mobile phone 1 includes a controller 51, an operating section 52, a display section 53, a voice input-output section 54, a wireless telephone communication section 55, a storage section 56, a short range wireless communication section 57, a hands-free control section 58, and a phonebook access control section 59.

The controller 51, being configured of a CPU, a ROM, a RAM, and the like, carries out a control of the whole of the mobile phone 1.

The operating section 52, being configured of operating keys, a touch pad, a touch panel, or the like, inputs a signal into the controller 51 in accordance with a user's operation.

The display section 53, being configured of a liquid crystal display, an organic EL display, or the like, displays a character and/or image in accordance with a control of the controller 51.

The voice input-output section 54, being configured of a speaker and a microphone, carries out an input and output of a voice communicated by the wireless telephone communication section 55, an output of a voice or music of music content or video content, and the like.

The wireless telephone communication section 55 carries out a voice communication or packet communication via the base station 3. For example, in the event of transmitting a voice by a voice communication, the wireless telephone communication section 55 obtains data by signal processing such as coding and error control to a voice data obtained by the microphone, convert the data into a radio wave, and transmits the radio wave to the base station 3. Also, in the event of receiving a voice, a radio wave is received from the base station 3, a signal processing such as a decoding or an error correction is carried out after converting from the radio wave to an electrical signal, and the voice is output from the speaker of the voice input-output section 54.

The storage section 56 stores various kinds of application software, information registered by the user, and the like. A phonebook database 56a, in which phonebook data is registered, is also included in the storage section 56. A telephone number for telephone communication, and a name, residence address, e-mail address, and the like, correlated to the telephone number, are included in the phonebook data.

The short range wireless communication section 57, being configured of a wireless communication module such as the Bluetooth® module, or the like, which uses a radio wave with less wireless transmission power than that of the wireless telephone communication section 55, carries out a wireless communication with an external device such as a car kit 2. Hereafter, a description will be given assuming that the short range wireless communication section 57 carries out a session with an external device via Bluetooth® link. In the event of connecting with an external device via the Bluetooth®, it is possible to realize a hands-free telephone call using the HFP (Hands-Free Profile), and it is possible to carry out a phonebook forwarding using the PBAP.

The hands-free control section 58 carries out a hands-free control for enabling a hands-free telephone call, with voice communication transmitted and received by the wireless telephone communication section 55, from the car kit 2 via the Bluetooth® session.

The phonebook access control section 59 carries out a control for forwarding the phonebook data registered in the phonebook database 56a to an external device, using the short range wireless communication section 57.

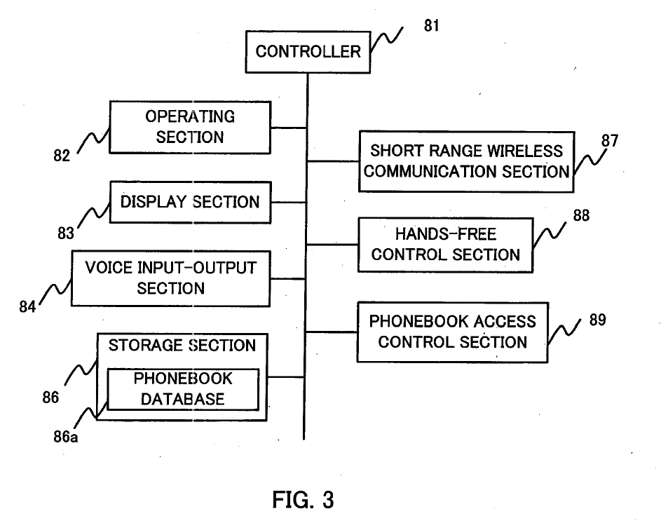

FIG. 3 is a block diagram showing a configuration of the car kit 2 according to the embodiment connectable to the mobile phone 1 according to the embodiment via the Bluetooth® session. The car kit 2 includes a controller 81, an operating section 82, a display section 83, a voice input-output section 84, a storage section 86, a short range wireless communication section 87, a hands-free control section 88, and a phonebook access control section 89.

The controller 81, being configured of a CPU, a ROM, a RAM, and the like, carries out a control of the whole of the car kit 2.

The operating section 82, being configured of operating keys, a touch panel, or the like, inputs a signal into the controller 81 in accordance with a user's operation.

The display section 83, being configured of a liquid crystal display, an organic EL display, or the like, displays a character or image in accordance with a control of the controller 81.

The voice input-output section 84, being configured of a speaker and a microphone, carries out an output of a voice or music of music content or video content, and the like.

The storage section 86 stores various kinds of application software, information registered by the user, and the like. A phonebook database 86a, in which is registered phonebook data forwarded from the mobile phone 1 by a process to be described hereafter, is also included in the storage section 86.

The short range wireless communication section 87, being configured of a wireless communication module such as a Bluetooth® module, or the like, which uses a radio wave with low wireless transmission power, carries out a wireless communication with an external device.

The hands-free control section 88 controls a hands-free telephone call via the mobile phone 1, using the short range wireless communication section 87, if the mobile phone 1 is connected.

The phonebook access control section 89 controls to acquire the phonebook data from the mobile phone 1 using the short range wireless communication section 87. The phonebook data forwarded from the mobile phone 1 are stored in the phonebook database 86a of the storage section 86. Then, the phonebook data stored in the phonebook database 86a may, for example, be displayed in the display section 83 in accordance with an operation from the operating section 82, or referred to when an incoming voice call is forwarded from the mobile phone 1 by the hands-free control section 88, and then displayed in the display section 83.

A description will be given of a process when a hands-free session and a session for phone book forwarding (hereafter called a PBAP session) are established by the mobile phone 1 and car kit 2. When the phonebook forwarding from the mobile phone 1 and car kit 2 is carried out in accordance with the PBAP, firstly, the PBAP session is established between the mobile phone 1 and car kit 2. In order to establish the PBAP session with car kit 2, it is necessary that an authentication for HFP with car kit 2 is carried out. When carrying out an authentication for HFP, the mobile phone 1 carries out pairing. In pairing procedure, the mobile phone 1 searches peripheral hands-free devices, selects a hands-free device to register as a device from among the hands-free devices which are searched. Then the mobile phone 1 confirms a service with which the hands-free device is compliant, exchanges PINs. When the authentication is completed, information indicating device attributes, such as a device name and an authentication key, of the authenticated hands-free device is stored in the storage section 56 of the mobile phone 1, and it is possible to establish the session for the hands-free function.

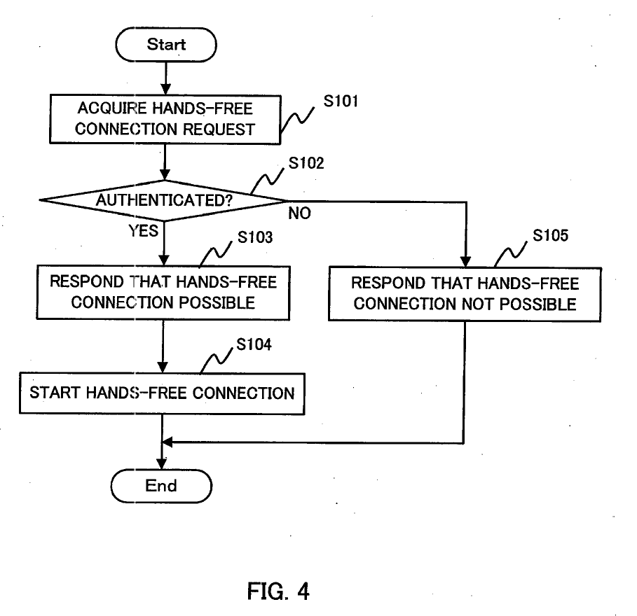

FIG. 4 is a flowchart showing a process when the hands-free control section 58 of the mobile phone 1 receives a request (hereafter called a hands-free connection request) to establish a session for a hands-free function. Firstly, the hands-free control section 58 acquires a hands-free connection request received via the short range wireless communication section 57 (S101). Then, the hands-free control section 58, referring to the storage section 56, determines whether or not the device has been authenticated (S102). In the event that the device has been authenticated, information indicating the device attributes, such as the device name and authentication key, of the authenticated device is stored in the storage section 56. If, in step S102, the hands-free control section 58, referring to the storage section 56, determines that the hands-free connection request is not from a authenticated hands-free device (S102: No), the hands-free control section 53 transmits a response to the hands-free device, via the short range wireless communication section 57, indicating that the hands-free connection is not possible (S105). In step S105, it is also acceptable to configure in such a way that, after the response indicating that the hands-free connection is not possible is delivered from the hands-free control section 58, the hands-free control section 58 of the mobile phone 1 starts the authentication with the hands-free device, and carries out the hands-free connection after the authentication is completed.

Meanwhile if, in step S102, the hands-free control section 58, referring to the storage section 56, determines that the hands-free connection request is from a authenticated hands-free device (S102: Yes), the hands-free control section 58 transmits a response to the hands-free device, via the short range wireless communication section 57, indicating that the hands-free connection is possible (S103). Then, the hands-free control section 58 establishes the hands-free connection (S104).

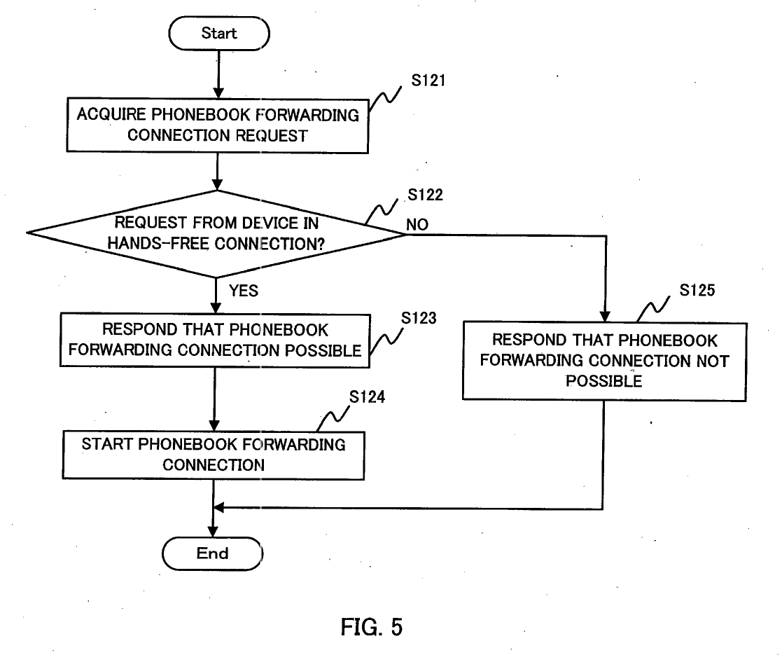

FIG. 5 is a flowchart showing a process when the phonebook access control section 59 of the mobile phone 1 receives a request (hereafter called a PBAP connection request) to establish a PBAP session. Firstly, the phonebook access control section 59 acquires a PBAP connection request received from the car kit 2 via the short range wireless communication section 57 (S121). Then, the phonebook access control section 59 confirms whether or not it is a PBAP connection request output from a hands-free device for which a hands-free session is established (S122).

If the phonebook access control section 59 determines, in step S122, that it is not a PBAP connection request from a hands-free device for which a hands-free session is established (S122: No), the phonebook access control section 59 transmits a response signal to the relevant hands-free device, via the short range wireless communication section 57, indicating that the PBAP connection is not possible (S125).

Contrarily, if the phonebook access control section 59 determines, in step S122, that it is a PBAP connection request output from a hands-free device for which a hands-free session is established (S122: Yes), the phonebook access control section 59 transmits a response signal to the relevant hands-free device, via the short range wireless communication section 57, indicating that the PBAP connection is possible (S123). Then, the phonebook access control section 59 establishes the PBAP session (S124).

In the event that the session for the PBAP cannot be established because the hands-free device is not in a hands-free session, it is acceptable that the hands-free control section 58 establishes a hands-free session by the process shown in FIG. 4, informing the hands-free device that the PBAP connection is possible, using the phonebook access control section 59, and starts the phonebook forwarding session.

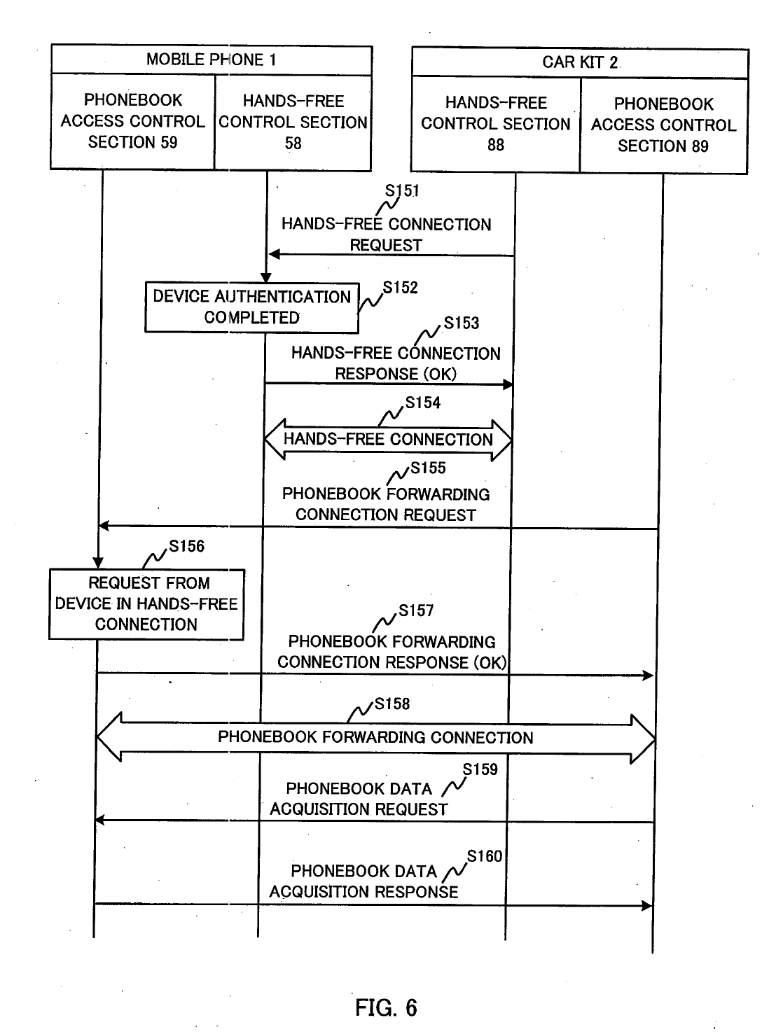

FIG. 6 is a sequence diagram showing a process from a condition in which no hands-free session is established between the mobile phone 1 and car kit 2, until phonebook forwarding is carried out from the mobile phone 1 to the car kit 2. FIG. 6 shows a process in a condition in which the mobile phone 1 has been authenticated the car kit 2.

Firstly, on a predetermined operation requesting a hands-free session between mobile phone 1 and car kit 2 being input by the user into the car kit 2, via the operating section 82, the hands-free control section 88 of the car kit 2 transmits a hands-free connection request to the hands-free control section 58 of the mobile phone 1 (S151). The hands-free control section 58 receives the hands-free connection request, and confirms whether or not the car kit 2 which sent the request has been authenticated by using information identifying the car kit 2 which is including in the request (S152). Then, in the event of confirming that the hands-free device has been authenticated, the hands-free control section 58 transmits information to the hands-free control section 88, as a hands-free connection response, indicating that the hands-free connection is possible (S153). Then, the hands-free session is established (S154).

Subsequently, the phonebook access control section 89 of the car kit 2 transmits a PBAP connection request to the phonebook access control section 59 of the mobile phone 1 (S155). The phonebook access control section 59 of the mobile phone 1, receives PBAP connection request, and confirms whether or not the car kit 2 which sent the PBAP connection request is a device which currently connects by the hands-free session (S156). Then, in the event that it is a PBAP connection request from a device in a hands-free connection, the phonebook access control section 59 transmits a response to the phonebook access control section 89 of the car kit 2 indicating that a connection is possible (S157), and the PBAP session is established (S158). Meanwhile, in the event that, after the PBAP session is established, the phonebook access control section 59 of the mobile phone 1 receives a phonebook data access request from the phonebook access control section 89 of the car kit 2 (S159), the phonebook access control section 59 forwards the phonebook data registered in the phonebook database 56a to the phonebook access control section 89 of the car kit 2 (S160).

As heretofore described, the phonebook access control section 59 which receives a PBAP connection request accepts a session establishment request for a phonebook forwarding only from a hands-free device for which a hands-free session is already established. Because of this, provided that a session for a hands-free session is established, it is possible to eliminate pairing procedure when establishes the PBAP session. Meanwhile, when establishes a hands-free session, as shown in FIG. 4, it is necessary that the device has been authenticated. Because of this, it is possible to maintain security while also eliminating the pairing procedure when establishes the PBAP session.

It is also acceptable that the phonebook access control section 59 of the mobile phone 1, in a condition in which no hands-free session is established, controls in such a way as not to accept a PBAP connection request. In other words, the phonebook access control section 59 which carries out the control, with an establishment of the hands-free condition as a trigger, shifts to a condition of waiting to receive a PBAP connection request. When it is in the condition of waiting to receive a PBAP connection request, the phonebook access control section 59 accepts the PBAP connection request in accordance with the flowchart shown in FIG. 4, and carries out the process of steps S121 to S125. As opposed to this, when it is not in the condition of waiting to receive a PBAP connection request, the phonebook access control section 59, even supposing that it receives a phonebook forwarding request, does not carry out the determination process shown in step S122.

Alternatively, it is also acceptable that the phonebook access control section 59 of the mobile phone 1 controls in such a way as, in a condition in which there is no device for which a HFP authentication has been carried out by the hands-free control section 58, not to accept a PBAP connection request.

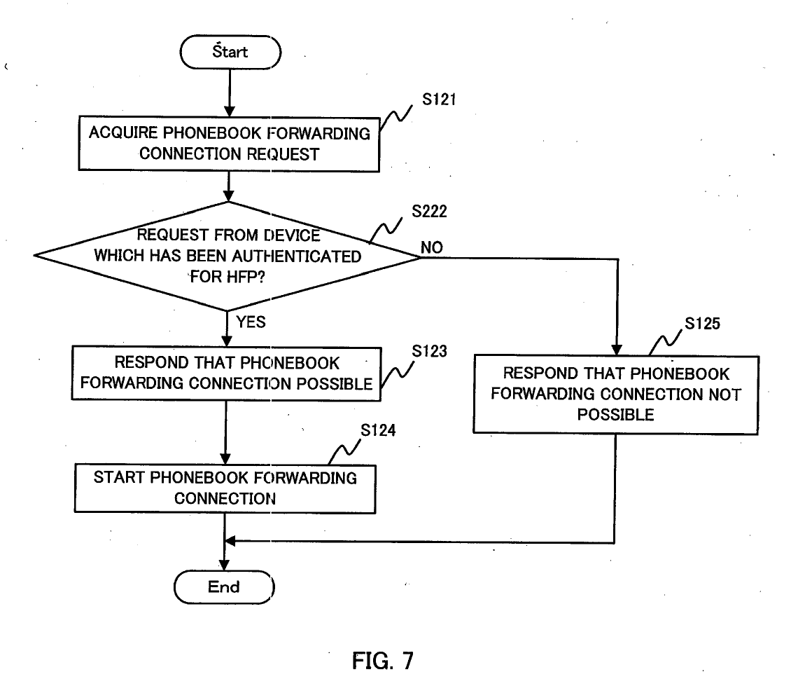

Also, it is also acceptable that the phonebook access control section 59 of the mobile phone 1 determines whether or not to establish a PBAP session depending on whether or not the authentication for HFP has been done. A process of the mobile phone at this time is shown in FIG. 7. A step of FIG. 7 which is the same as one of FIG. 4 is indicated by the same reference numeral and character, and a detailed description is omitted.

The phonebook access control section 59 of the mobile phone 1, on receiving a PBAP connection request (S121), refers to the storage section 56, using the information included in the PBAP connection request identifying a device sent the request, determines whether or not the device has been authenticated for HFP (S222). If the hands-free has been authenticated for HFP (Yes in S222), the phonebook access control section 59 responds to the hands-free device to the effect that the PBAP connection is possible (S123). In this case, the mobile phone 1 is possible to establish the PBAP session with the device, even in the event that the device which has been authenticated for HFP is not in a hands-free connection.

Also, it is acceptable to also carry out the authentication with a device when establishing a protocol at a higher layer than the Bluetooth® which carries out the phonebook forwarding and hands-free connection. For example, when establishing an OBEX protocol, which is a protocol at a higher layer than Bluetooth® which carries out the phonebook forwarding and hands-free connection, the authentication process is carried out at that protocol level. By also carrying out the authentication process when establishing a higher-level protocol in this way, it is possible to further strengthen security.

By adopting the configuration of the heretofore described kind of embodiment, it is possible to reduce the user's operations relating to the pairing for the PBAP, while still maintaining security.

The heretofore described embodiment not being limiting, it is acceptable to change appropriately, without departing from the scope of the invention. For example, a description is given with a mobile phone and car kit as examples but, it being sufficient that they are devices including a hands-free function and a phonebook forwarding function, and it is also acceptable that they are a personal computer or personal digital assistant (PDA).

The phonebook data can be an incoming calls history, an outgoing calls history, and a missed calls history. (refer to Phone Book Access Profile specification Ver. 10 p. 13)

According to an embodiment of the invention, it is possible to provide a wireless communication terminal which can reduce a user's operations for pairing, while maintaining security when carrying out a phonebook forwarding function.

What is claimed is:

1. A wireless communication terminal, comprising:
a first radio interface to communicate with a device by a short-range wireless communication;
a memory to store phone book data; and
a phonebook access control unit to establish a session for phonebook forwarding with the device when the device has been authenticated for a hands-free session which is a session for connecting the device and the wireless communication terminal by the short-range wireless communication.

2. The wireless communication terminal according to claim 1, further comprising:
a second radio interface to communicate with a base station;
a hands-free control unit to establish a hands-free session with the device to control placing or receiving calls via the second radio interface from the device, when the device has been authenticated for a hands-free session; and
wherein the phonebook access control unit establishes a session for phonebook forwarding with the device in case of establishing hands-free session with the device.

3. The wireless communication terminal according to claim 1, wherein the phonebook access control unit establishes a hands-free session when the wireless communication terminal receives a request for establishment of phonebook forwarding session from the device.

4. The wireless communication terminal according to claim 1, wherein the phonebook access control unit rejects a request for establishment of phonebook forwarding session if the request is transmitted from the device which has not been authenticated for hands-free session.

5. The wireless communication terminal according to claim 1, wherein the phonebook access control unit rejects a request for establishment of a phonebook forwarding session if the request is transmitted from the device which is not connecting by the hands-free session.

6. The wireless communication terminal according to claim 1, wherein the session for phonebook forwarding is a session based on the Phone Book Access profile.

7. The wireless communication terminal according to claim 1, wherein short-range wireless communication is Bluetooth.

8. A wireless communication terminal, comprising:
means for communicating with a device via a short-range wireless session;
means for communicating with a base station;
a memory configured to store phone book data composed of at least one phonebook data item; and
means for establishing a hands-free session with a device to control placing and receiving calls via the second radio interface by the device, if the device has been authenticated for hands-free session, said session control unit to establish a phonebook forwarding session if a device which has been authenticated for hands-free session requests establishing session for phonebook forwarding.

9. The wireless communication terminal according to claim 8, wherein the establishing means establishes a session for phonebook forwarding if a device which has been authenticated for a hands-free session and be connecting a hands-free session requests establishing session for phonebook forwarding.

10. The wireless communication terminal according to claim 8, wherein the establishing means rejects a request for establishment of phonebook forwarding session if the request is transmitted from a device which has not been authenticated for hands-free session.

11. The wireless communication terminal according to claim 8, wherein the establishing means rejects a request for establishment of a phonebook forwarding session if the request is transmitted from a device which is not connecting by the hands-free session.

12. A method for wireless communication comprising:
receiving a request for establishing a session for phone book forwarding from a device by a short-range wireless communication;
determining whether the device is authenticated for a hands-free session which is a session for connecting the device and the wireless communication terminal by the short-range wireless communication; and
establishing a phonebook forwarding session if the device is authenticated for a hands-free session.

13. The method for wireless communication according to claim 12, further comprising:
receiving a request for establishing a session for hands-free session from the device by the short-range wireless communication;
establishing a hands-free session if the device is authenticated for a hands-free session; and
wherein the phonebook forwarding session is established if the hands-free session is established with the device.
